(19) United States
(12) Patent Application Publication
(10) Pub. No.: US 2025/0231371 A1
(43) Pub. Date: Jul. 17, 2025

(54) DRIVING MECHANISM

(71) Applicant: TDK TAIWAN CORP., Taoyuan City (TW)

(72) Inventors: Chao-Yuan CHANG, Taoyuan City (TW); Po-Xiang ZHUANG, Taoyuan City (TW); Jui-Ta CHIEN, Taoyuan City (TW); Wei-Jhe SHEN, Taoyuan City (TW); Ko-Lun CHAO, Taoyuan City (TW); Yi-Ho CHEN, Taoyuan City (TW); Sin-Jhong SONG, Taoyuan City (TW)

(21) Appl. No.: 19/016,642

(22) Filed: Jan. 10, 2025

Related U.S. Application Data
(60) Provisional application No. 63/619,916, filed on Jan. 11, 2024.
(60) Provisional application No. 63/565,279, filed on Mar. 14, 2024.

(51) Int. Cl. G02B 7/08; G02B 27/64

(52) U.S. Cl. CPC G02B 7/08; G02B 27/646

(57) ABSTRACT

A driving mechanism for moving an optical element is provided. The driving mechanism includes a fixed part, a movable part, and a driving assembly. The movable part is movably connected to the fixed part for holding the optical element. The driving assembly is configured for moving the movable part relative to the fixed part.

### CROSS REFERENCE TO RELATED APPLICATIONS

This application claims the benefit of U.S. Provisional Application No. 63/619,916, filed Jan. 11, 2024, and U.S. Provisional Application No. 63/565,279, filed Mar. 14, 2024, both of which are incorporated by reference herein in their entireties.

### BACKGROUND OF THE INVENTION

### Field of the Invention

The present invention relates to a driving mechanism, and, in particular, to a driving mechanism for moving an optical element.

### Description of the Related Art

As technology has advanced, a lot of electronic devices (for example, laptop computers and smartphones) have incorporated the functionality of taking photographs and recording video. These electronic devices have become more commonplace, and have been developed to be more convenient and thin. More and more options are provided for users to choose from.

In some electronic devices, several coils and magnets corresponding thereto are usually used for adjusting the focus of a lens. However, miniaturization of these electronic devices may increase the difficulty of mechanical design, and it may also lead to low reliability and low driving force for moving the lens. Therefore, addressing the aforementioned problems has become a challenge.

### BRIEF SUMMARY OF THE INVENTION

An embodiment of the present invention provides a driving mechanism for moving an optical element. The driving mechanism includes a fixed part, a movable part, and a driving assembly. The movable part is movably connected to the fixed part for holding the optical element. The driving assembly is configured for moving the movable part relative to the fixed part.

In some embodiments, the driving mechanism further includes a metal piece and a plurality of ball elements affixed to the metal piece, wherein the metal piece has a C-shaped structure, and the movable part includes a frame and a holder received in the holder, wherein the optical element is disposed on the holder, and the ball elements are in contact between the frame and the holder.

### BRIEF DESCRIPTION OF THE DRAWINGS

The present invention can be more fully understood by reading the subsequent detailed description and examples with references made to the accompanying drawings, wherein:

FIG. 1 is an exploded diagram of a driving mechanism 100 in accordance with an embodiment of the invention.

FIG. 2 is another exploded diagram of the driving mechanism 100 in FIG. 1.

FIG. 3 is a perspective diagram of the driving mechanism 100 in FIGS. 1 and 2 after assembly.

FIG. 4 is another perspective diagram of the driving mechanism 100 in FIGS. 1 and 2 after assembly.

FIG. 5 shows a cross-sectional view of the driving mechanism 100 taken along line A1-A2 in FIG. 3.

FIG. 6 shows a cross-sectional view of the driving mechanism 100 taken along line A3-A4 in FIG. 3.

FIG. 7 is an exploded diagram of the holder LH, the metal piece T, and the ball elements B1-B3.

FIG. 8 is a top view of the frame F.

FIG. 9 is a bottom view of the holder LH.

FIG. 10 is a top view of the holder LH and the frame F after assembly.

FIG. 11 is an exploded diagram of a driving mechanism 200 in accordance with another embodiment of the invention.

FIG. 12 is another exploded diagram of the driving mechanism 200 in FIG. 11.

FIG. 13 is a perspective diagram of the driving mechanism 200 in FIGS. 11 and 12 after assembly.

FIG. 14 is another perspective diagram of the driving mechanism 200 in FIGS. 11 and 12 after assembly.

FIG. 15 shows a cross-sectional view of the driving mechanism 200 taken along line A5-A6 in FIG. 13.

FIG. 16 shows a cross-sectional view of the driving mechanism 200 taken along line A7-A8 in FIG. 13.

FIG. 17 is an exploded diagram of the holder LH, the metal piece T, and the ball elements B1-B3 before assembly.

FIG. 18 is a perspective diagram showing a part of the driving mechanism 200 after assembly.

FIG. 19 is a partial cross-sectional view of a driving mechanism 300 in accordance with another embodiment of the invention.

### DETAILED DESCRIPTION OF THE INVENTION

The making and using of the embodiments of the driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

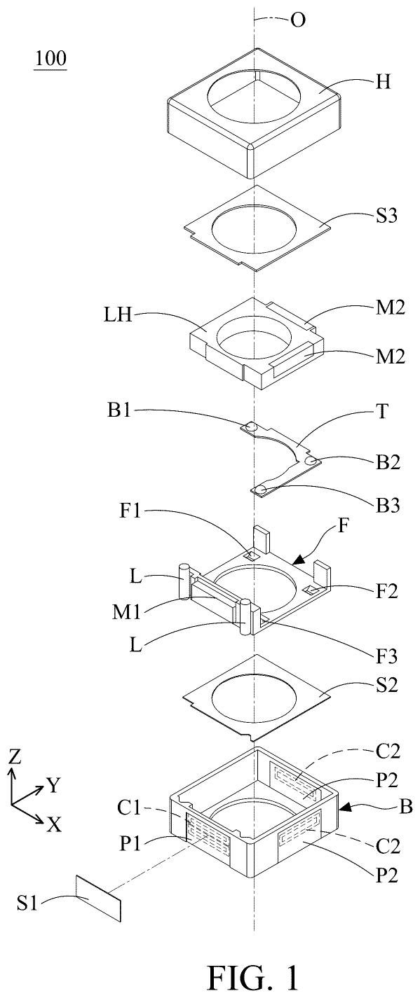

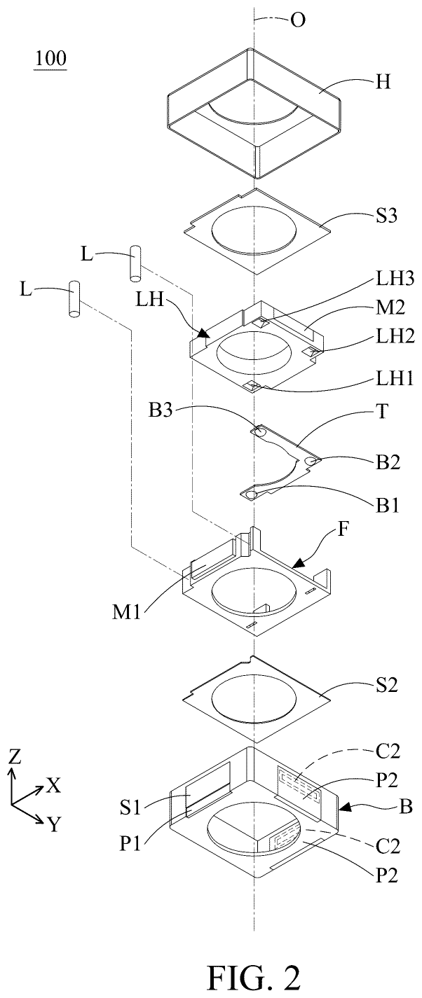

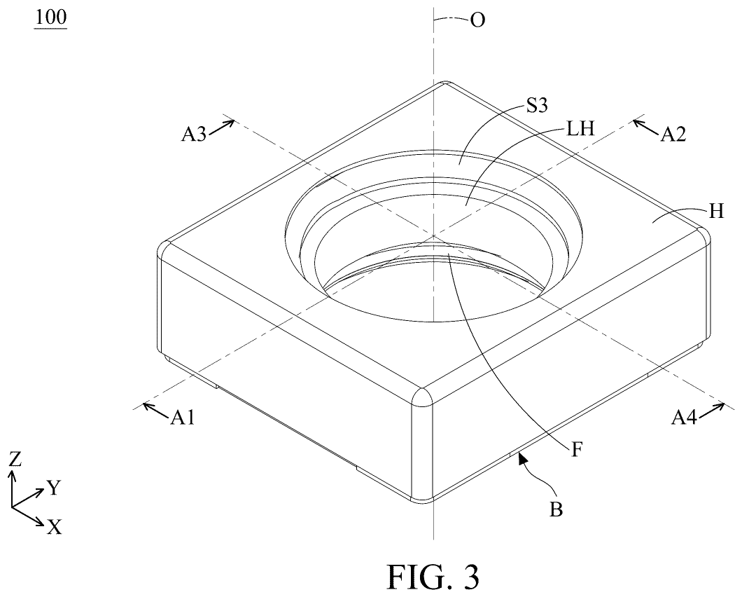

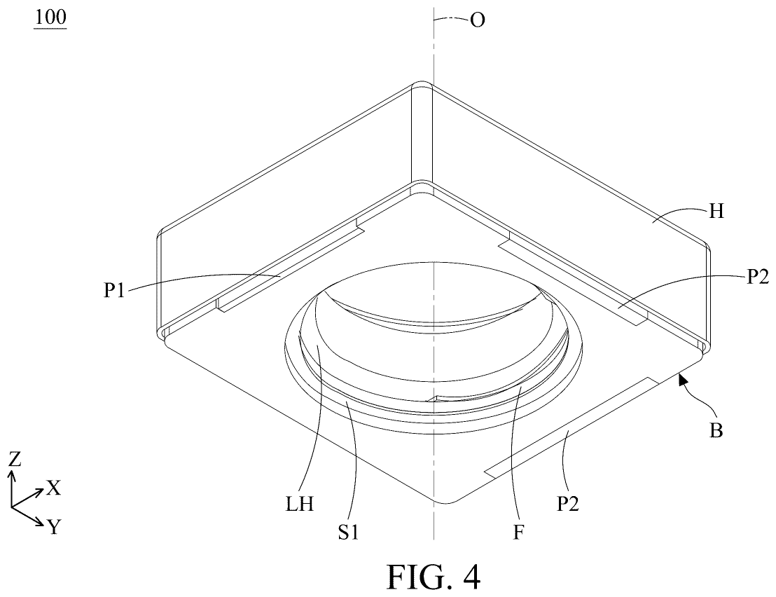

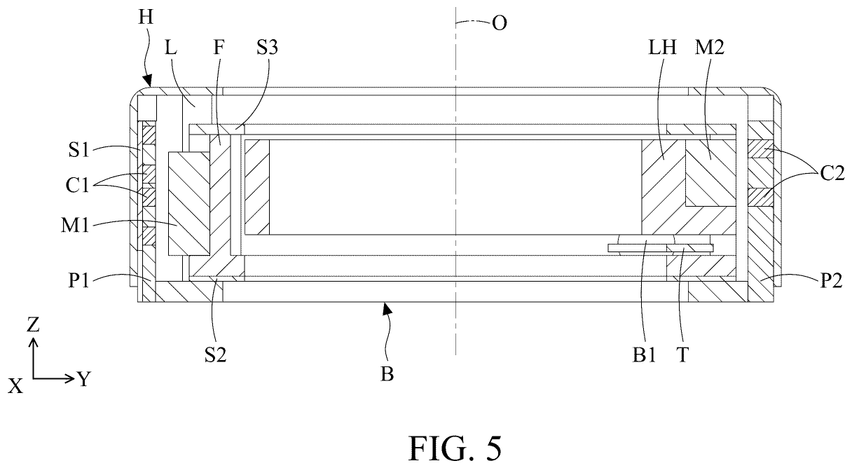

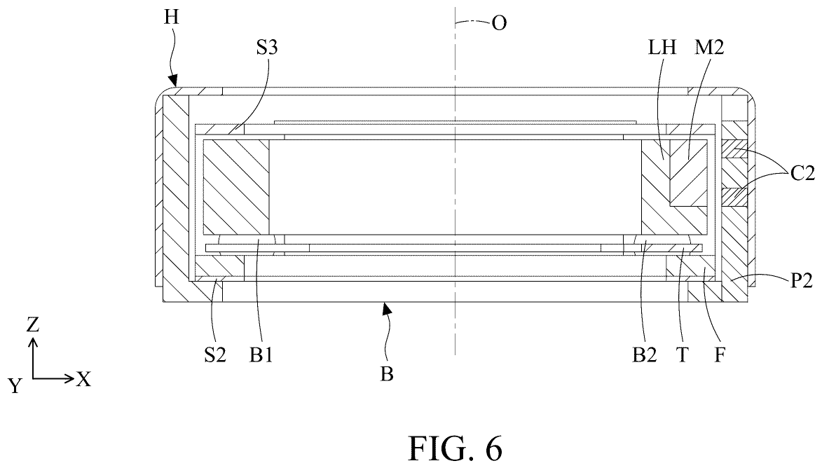

FIG. 1 is an exploded diagram of a driving mechanism 100 in accordance with an embodiment of the invention. FIG. 2 is another exploded diagram of the driving mechanism 100 in FIG. 1. FIG. 3 is a perspective diagram of the driving mechanism 100 in FIGS. 1 and 2 after assembly. FIG. 4 is another perspective diagram of the driving mechanism 100 in FIGS. 1 and 2 after assembly. FIG. 5 shows a cross-sectional view of the driving mechanism 100 taken along line A1-A2 in FIG. 3. FIG. 6 shows a cross-sectional view of the driving mechanism 100 taken along line A3-A4 in FIG. 3.

Referring to FIGS. 1-6, the driving mechanism 100 is a Voice Coil Motor (VCM) which may be disposed in a cell phone or other portable electronic device for driving an optical element (e.g. optical lens) to move, thereby achieving the function of auto-focusing (AF) or Optical Image Stabilization (OIS).

The driving mechanism 100 primarily comprises a hollow housing H, a base B, a holder LH, a metal piece T, several ball elements B1-B3, and a frame F. In this embodiment, the housing H and the base B are affixed to each other, thus forming a fixed part of the driving mechanism 100. Additionally, an optical element (e.g. optical lens) can be disposed in the holder LH. Here, the holder LH and the frame F constitute a movable part of the driving mechanism 100 that can move relative to the fixed part (the housing H and the base B).

In this embodiment, two rods L extending along the Z axis are in contact between the frame F and the base B. Therefore, the frame F can slide relative to the base B along the vertical direction (Z direction), thereby achieving the function of auto-focusing (AF). Specifically, the metal piece T has a C-shaped structure, wherein the ball elements B1-B3 are mounted on the metal piece T and in contact between the holder LH and the frame F. Thus, the holder LH can move relative to the frame F along the horizontal direction (X or Y direction), thus achieving the function of auto-focusing (AF) or optical Image Stabilization (OIS).

With the configuration described above, external light can enter the driving mechanism 100 in the −Z direction and then propagate through the optical element to an image sensor (not shown) below the base B to form a digital image.

It should be noted that a circuit board P1 and a magnetic permeable sheet S1 are disposed on a lateral side of the quadrilateral base B, and a first coil C1 (e.g. planar coil) is embedded in the circuit board P1. Moreover, two circuit boards P2 are disposed on two adjacent sides of the base B, and two second coils C2 (e.g. planar coils) are embedded in the circuit boards P2, respectively.

The first and second coils C1 and C2 are located corresponding to a first magnet M1 on the frame F and two second magnets M2 on the holder LH. The first magnet M1 is situated between the two rods L along a first axis (X axis). Moreover, the circuit board P1 and the first coil C1 are situated between the magnetic permeable sheet S1 and the first magnet M1 along a second axis (Y axis). Here, the first, second magnets C1, C2 and the first, second coils C1, C2 constitute a driving assembly of the driving mechanism 100.

When a current signal is applied to the first coil C1, an electromagnetic force can be generated by the first coil C1 and the first magnet M1, so that the frame F, the holder LH, and the optical element received in the holder LH are driven to move relative to the fixed part (the base B and the housing H) along the optical axis O (Z axis), thereby achieving the function of auto-focusing (AF) or optical Image Stabilization (OIS).

Additionally, when a current signal is applied to the second coils C2, an electromagnetic force can be generated by the second coils C2 and the second magnets M2, so that the holder LH and the optical element received therein are driven to move relative to the frame F in the horizontal direction (X or Y direction), thereby achieving the function of optical Image Stabilization (OIS), wherein the horizontal direction is perpendicular to the optical axis O of the optical element.

It can be seen in FIGS. 1 and 2 that the ball element B1 (first ball element) is movably received in the first recess F1 of the frame F and the first cavity LH1 of the holder LH. Similarly, the ball element B2 (second ball element) is movably received in the second recess F2 of the frame F and the second cavity LH2 of the holder LH, and the ball element B3 (third ball element) is movably received in the third recess F3 of the frame F and the third cavity LH3 of the holder LH.

As shown in FIGS. 1-4, a metal sheet S2 with high magnetic permeability is affixed to the bottom side of the frame F, and a restricting plate S3 (e.g. a metal plate with low magnetic permeability) is affixed to the top side of the frame F. In this configuration, a magnetic attractive force is generated between the metal sheet S2 and the first and second magnets M1 and M2, whereby the ball elements B1-B3 are stably pressed between the holder LH and the frame F. Moreover, the restricting plate S3 can contact the housing H and prevent the holder LH from separating from the frame F.

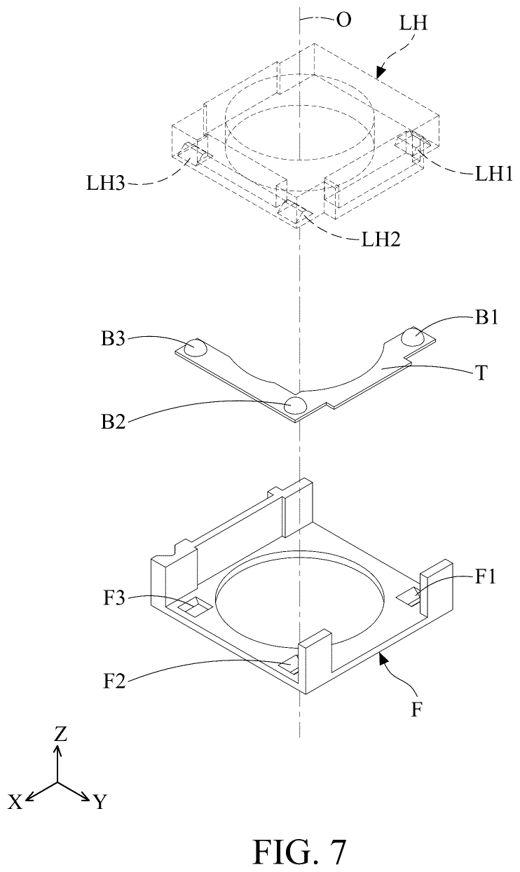

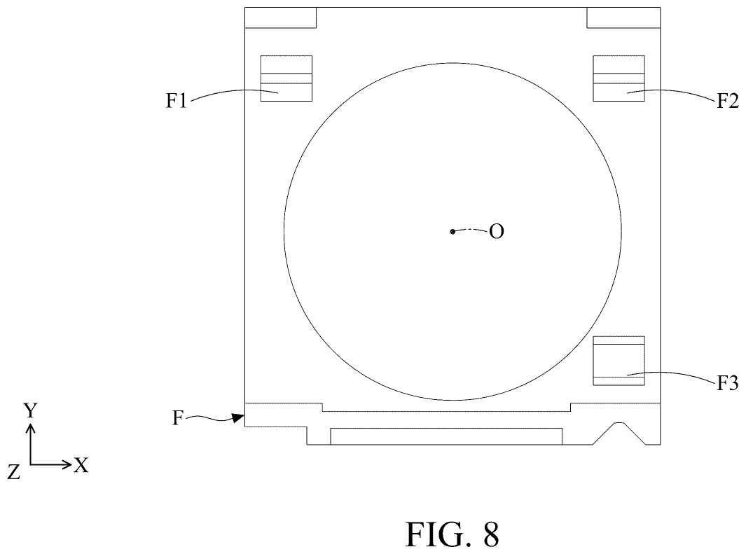

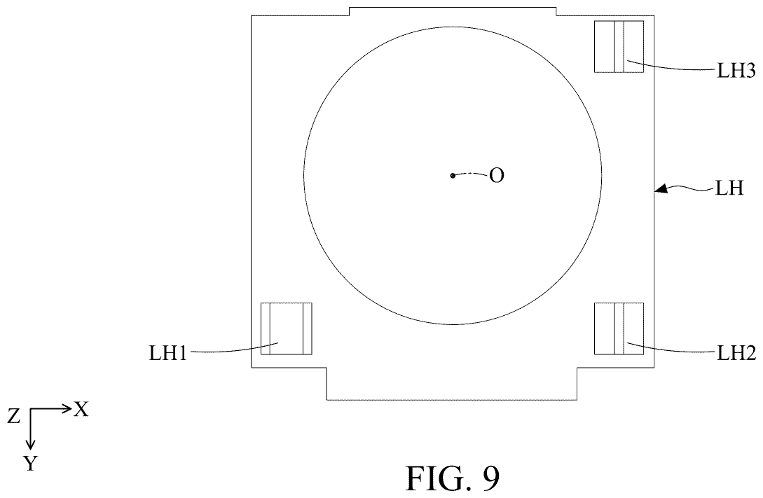

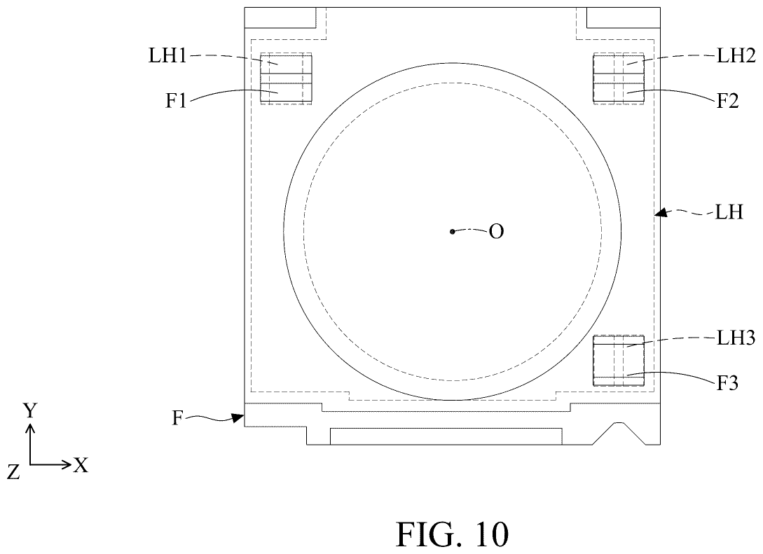

FIG. 7 is an exploded diagram of the holder LH, the metal piece T, and the ball elements B1-B3. FIG. 8 is a top view of the frame F. FIG. 9 is a bottom view of the holder LH. FIG. 10 is a top view of the holder LH and the frame F after assembly.

Referring to FIGS. 7-10, the first recess F1, the second recess F2, and the third recess F3 are formed on the top side of the frame F. The first cavity LH1, the second cavity LH2, and the third cavity LH3 are formed on the bottom side of the holder LH. Specifically, a first guiding groove along the X axis (first axis) is formed in each of the first, second and third recesses F1, F2, and F3, and a second guiding groove along the Y axis (second axis) is formed in each of the first, second and third cavities LH1, LH2, and LH3, wherein the first and second guiding grooves are tapered in cross-section.

It should be noted that the first guiding grooves of the first, second and third recesses F1, F2, and F3 are substantially perpendicular to the second guiding grooves of the first, second and third cavities LH1, LH2, and LH3. Therefore, the holder LH can only move relative to the frame F along the X axis (first axis) or the Y axis (second axis), and rotation of the holder LH relative to the frame F around the optical axis O can be efficiently prevented, thereby improving the efficiency and reliability of the driving mechanism 100.

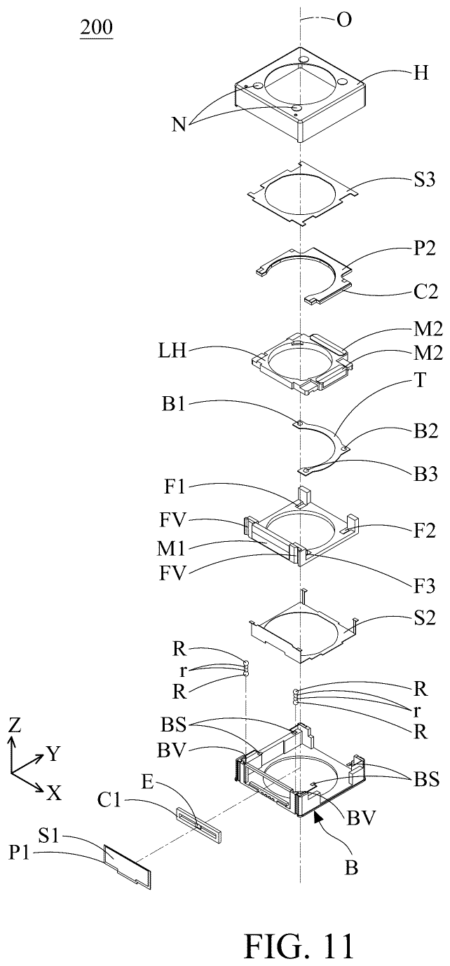

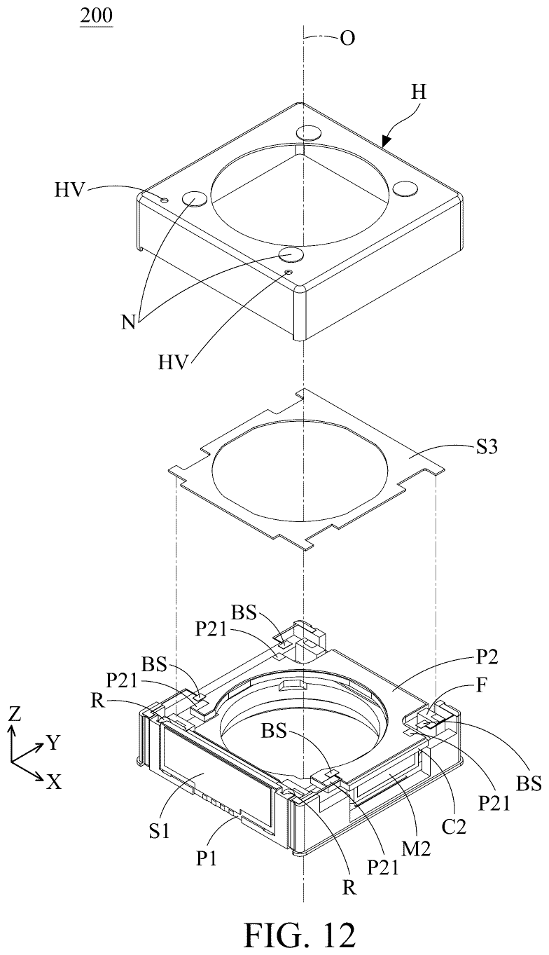

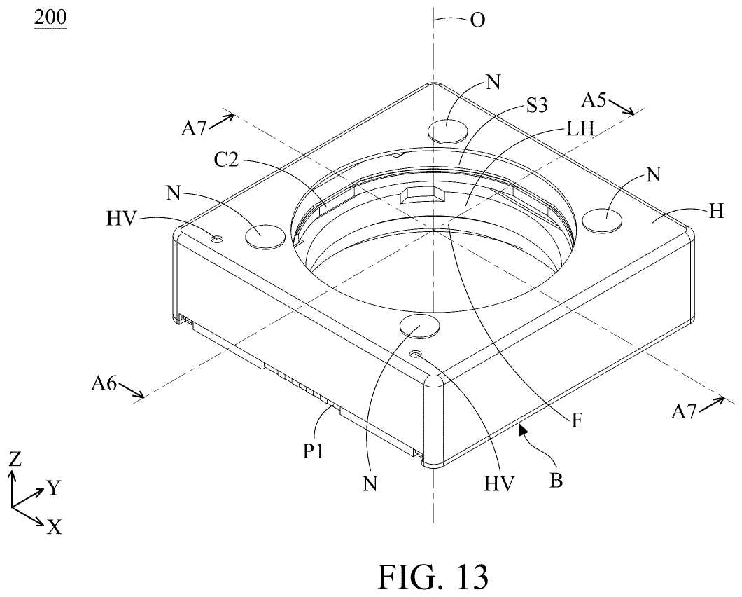

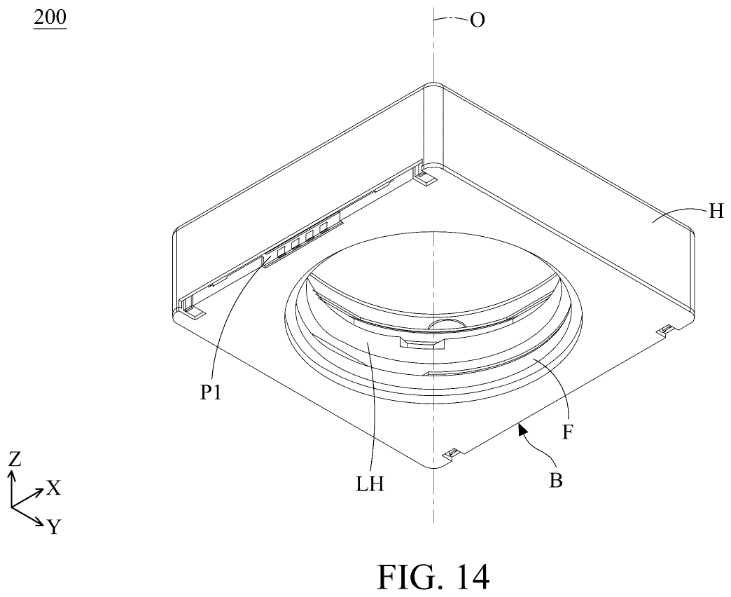

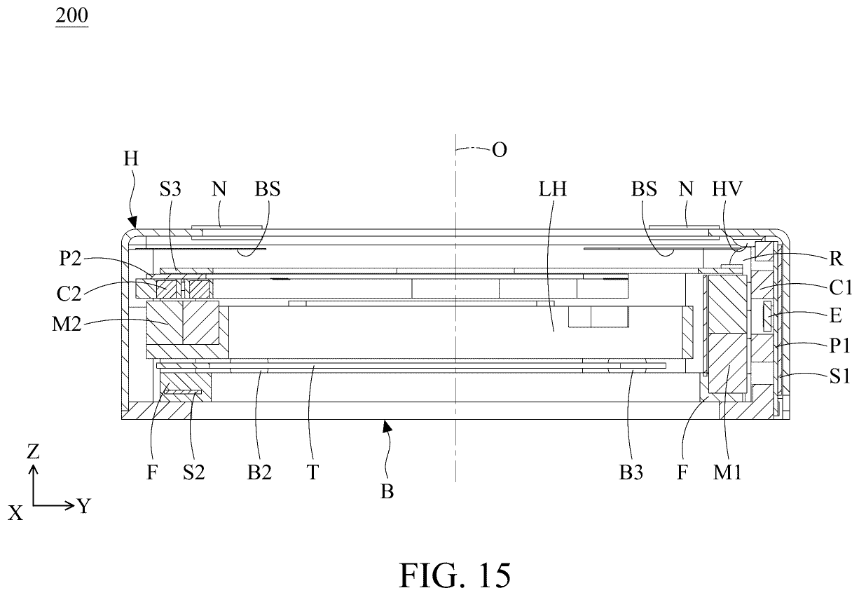

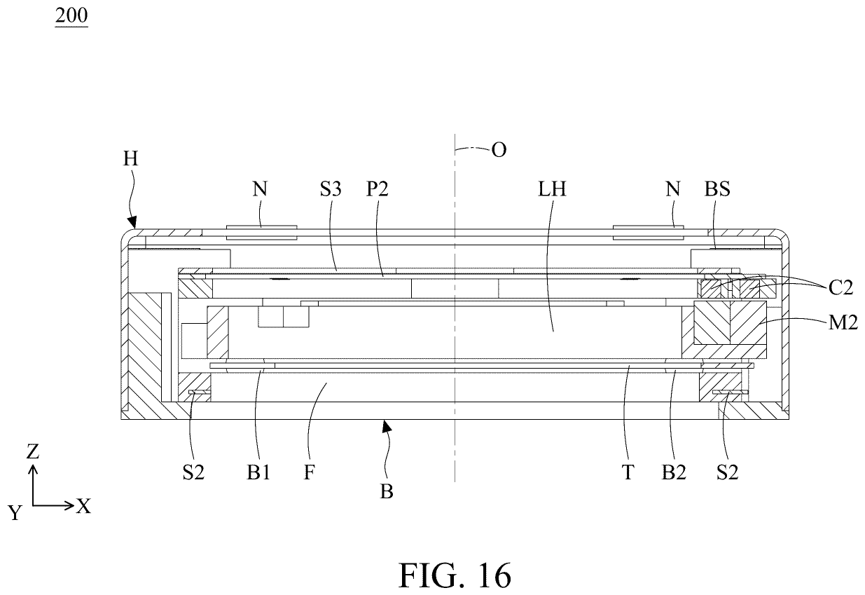

FIG. 11 is an exploded diagram of a driving mechanism 200 in accordance with another embodiment of the invention. FIG. 12 is another exploded diagram of the driving mechanism 200 in FIG. 11. FIG. 13 is a perspective diagram of the driving mechanism 200 in FIGS. 11 and 12 after assembly. FIG. 14 is another perspective diagram of the driving mechanism 200 in FIGS. 11 and 12 after assembly. FIG. 15 shows a cross-sectional view of the driving mechanism 200 taken along line A5-A6 in FIG. 13. FIG. 16 shows a cross-sectional view of the driving mechanism 200 taken along line A7-A8 in FIG. 13.

The driving mechanism 200 of FIGS. 11-16 is different from the driving mechanism 100 of FIGS. 1-10 in that the rods L are replaced by the rollers R and r. In this embodiment, the rollers R and r are arranged along the optical axis O (Z axis) and positioned between the slot BV of the base B and the slot FV of the frame F. Here, the diameter of the rollers R is greater than the diameter of the rollers r, and the rollers r are restricted between the two rollers R.

It should be noted that the holder LH is movably received in the frame F, the restricting plate S3 is affixed to the top side of the frame F, and the ball elements B1-B3 are movably pressed between the holder LH and the frame F. Moreover, the circuit board P2 and the second coils C2 on the circuit board P2 are adhered to the bottom side of the restricting plate S3. Specifically, several metal sheet springs BS are connected between the circuit board P2 and the base B. Here, one end of the metal sheet spring BS is electrically connected to the conductive pad P21 of the circuit board P2, as shown in FIG. 12, and the other end of the metal sheet spring BS is embedded in the base B.

When a current signal is applied to the second coils C2, an electromagnetic force can be generated by the second coils C2 and the second magnets M2, so that the holder LH and the optical element received therein are driven to move relative to the frame F along the horizontal direction (X or Y direction), thereby achieving the function of optical Image Stabilization (OIS). It should be noted that the horizontal direction is perpendicular to the optical axis O of the optical element.

In this embodiment, the metal sheet springs BS are bendable and may be integrally formed with the plastic base B by insert molding. Thus, the second coils C2 can be electrically connected to an external circuit through the circuit board P2 and the metal sheet springs BS. Moreover, the first coil C1 and a magnetic field sensor E (e.g. hall effect sensor) are disposed on the inner surface of the circuit board P1, as shown in FIG. 11, wherein the magnetic field sensor E is surrounded by the first coil C1.

In some embodiments, the metal sheet S2 has high magnetic permeability, and it can be embedded in the plastic frame F by insert molding, so as to increase the structural strength of the frame F. Additionally, a magnetic attractive force can be generated between the metal sheet S2 and the second magnets M2, so that the ball elements B1-B3 are stably held between the holder LH and the frame F along the Z axis, thereby improving the efficiency of the driving mechanism 200.

It can be seen in FIGS. 11-16 that several buffer members N (e.g. rubber blocks) are mounted on the housing H. In this embodiment, the buffer members N extend through the housing H and contact the restricting plate S3 when the frame F moves relative to the base B in the Z direction to a limit position, whereby the risks of structural failures due to direct collision of the frame F with the housing H can be prevented.

Moreover, as shown in FIGS. 12 and 13, at least a positioning structure HV protrudes from the inner surface of the housing H and contacts one of the rollers R. Thus, the rollers R and r can be stably restricted within the slot BV of the base B and the slot FV of the frame F.

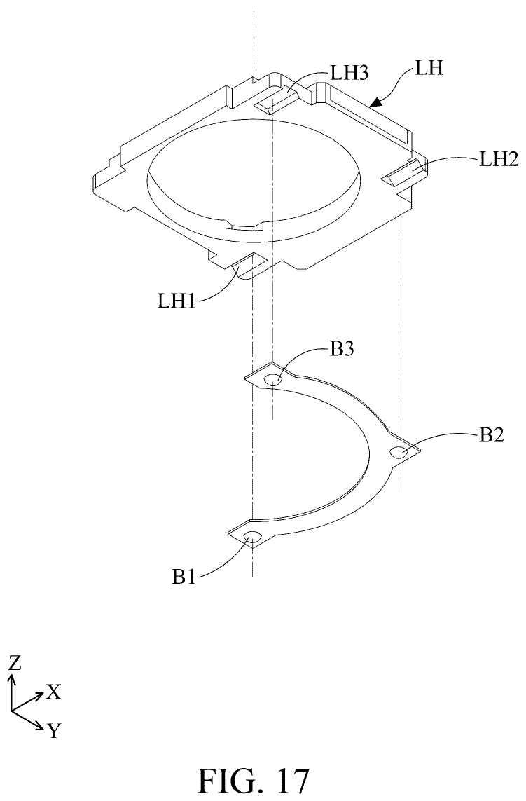

FIG. 17 is an exploded diagram of the holder LH, the metal piece T, and the ball elements B1-B3 before assembly.

Referring to FIGS. 11 and 17, the ball element B1 (first ball element) is movably received in the first recess F1 of the frame F and the first cavity LH1 of the holder LH. Similarly, the ball element B2 (second ball element) is movably received in the second recess F2 of the frame F and the second cavity LH2 of the holder LH, and the ball element B3 (third ball element) is movably received in the third recess F3 of the frame F and the third cavity LH3 of the holder LH.

It should be noted that a first guiding groove along the Y axis is formed in each of the first, second and third recesses F1, F2, and F3, and a second guiding groove along the X axis is formed in each of the first, second and third cavities LH1, LH2, and LH3, wherein the first and second guiding grooves are tapered in cross-section.

Here, the first guiding grooves of the first, second and third recesses F1, F2, and F3 are substantially perpendicular to the second guiding grooves of the first, second and third cavities LH1, LH2, and LH3. Therefore, the holder LH can only move relative to the frame F along the X axis or the Y axis, and rotation of the holder LH relative to the frame F around the optical axis O can be efficiently prevented, thereby improving the efficiency and reliability of the driving mechanism 200.

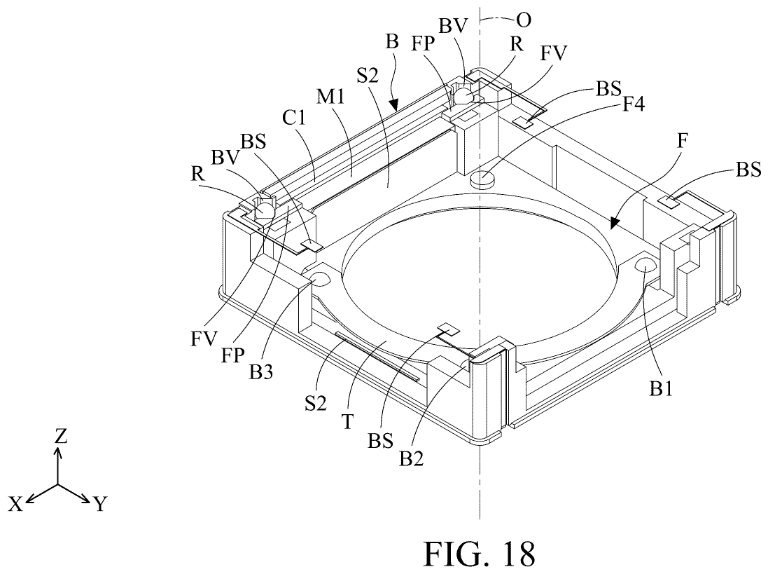

FIG. 18 is a perspective diagram showing a part of the driving mechanism 200 after assembly.

Referring to FIG. 18, the frame F of the driving mechanism 200 in this embodiment further forms a protruding structure F4 that extends from the upper surface of the frame F toward the holder LH. Specifically, the first, second, third recesses F1, F2, F3 and the protruding structure F4 are respectively located adjacent to the four corners of the quadrilateral frame F.

It should be noted that the ball elements B1-B3 are stably in contact between the holder LH and the frame F. In this configuration, the holder LH and the frame F are movably connected to each other along the Z axis via the ball elements B1-B3. When the center of the holder LH tilts relative to the frame F and deviates from the Z axis, the protruding structure F4 can contact the holder LH to prevent excessive tilt angle of the holder LH relative to the frame F, thereby enhancing the efficiency and reliability of the driving mechanism 200.

Additionally, it can be seen in FIG. 18 that at least a protrusion FP is formed on the top side of the frame F, wherein the top surface of the protrusion FP is higher than the restricting plate S3. The protrusion FP is located adjacent to the slot FV, so as to restrict the rollers R and r from separating from the slot FV of the frame F and the slot BV of the base B.

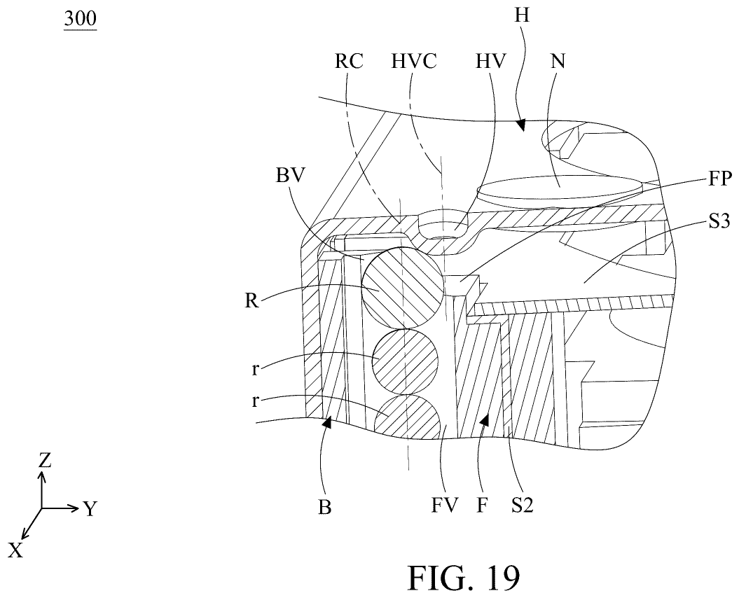

FIG. 19 is a partial cross-sectional view of a driving mechanism 300 in accordance with another embodiment of the invention.

In another embodiment of the invention, as shown in FIG. 19, a positioning structure HV is formed on the housing H of the driving mechanism 300. Specifically, the central axis HVC of the positioning structure HV is offset from the central axis RC of the rollers R and r toward the inner side of the driving mechanism 300. Here, the central axis HVC of the positioning structure HV is located between the buffer member N and the central axis RC of the rollers R and r along the horizontal axis (Y axis).

It should be noted that the positioning structure HV forms a pit on the top surface of the housing H. Hence, when a protection member (e.g. glass or buffer sheet) is adhered to the top surface of the housing H, the glue or adhesive can be accommodated in the pit of the positioning structure HV, whereby the protection member and the housing H can be firmly affixed to each other.

Additionally, since the central axis HVC of the positioning structure HV is offset from the central axis RC of the rollers R and r toward the inner side of the driving mechanism 300, the rollers R and r can be secured and positioned between the frame F and the base B, thereby enhancing the structural stability and reliability of the driving mechanism 300.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification.

As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A driving mechanism for moving an optical element that has an optical axis, comprising:
a fixed part;
a movable part, movably connected to the fixed part for holding the optical element; and
a driving assembly, configured for moving the movable part relative to the fixed part.

2. The driving mechanism as claimed in claim 1, further comprising a metal piece and a plurality of ball elements affixed to the metal piece, wherein the metal piece has a C-shaped structure, and the movable part includes a frame and a holder received in the holder, wherein the optical element is disposed on the holder, and the ball elements are in contact between the frame and the holder.

3. The driving mechanism as claimed in claim 2, wherein the frame forms a first recess, a second recess and a third recess, the holder forms a first cavity, a second cavity and a third cavity, and the ball elements includes a first ball element, a second ball element and a third ball element, wherein the first ball element is movably received in the first recess and the first cavity, the second ball element is movably received in the second recess and the second cavity, and the third ball element is movably received in the third recess and the third cavity.

4. The driving mechanism as claimed in claim 3, wherein the frame has a quadrilateral structure and further forms a protruding structure extending toward the holder, and the first, second, third recesses and the protruding structure are respectively located adjacent to four corners of the frame.

5. The driving mechanism as claimed in claim 4, wherein a first guiding groove is formed in the first recess and extends along a first axis, and a second guiding groove is formed in the first cavity and extends along a second axis that is perpendicular to the first axis.

6. The driving mechanism as claimed in claim 5, wherein the first and second axes are perpendicular to the optical axis.

7. The driving mechanism as claimed in claim 1, wherein the fixed part includes a housing and a base mounted to each other, and the movable part includes a frame and a holder received in the holder, wherein the optical element is disposed on the holder, and the driving assembly includes a first coil, a second coil, a first magnet, and a second magnet, wherein the first and second coils are disposed on different sides of the base, the first magnet is disposed on the frame and located corresponding to the first coil, and the second magnet is disposed on the holder and located corresponding to the second coil.

8. The driving mechanism as claimed in claim 7, further comprising a restricting plate and a metal sheet, wherein the restricting plate is affixed to a top side of the frame, the metal sheet is affixed to a bottom side of the frame, and the holder is located between the restricting plate and the metal sheet.

9. The driving mechanism as claimed in claim 8, wherein the metal sheet has high magnetic permeability.

10. The driving mechanism as claimed in claim 7, further comprising at least a rod in contact between the frame and the base.

11. The driving mechanism as claimed in claim 1, wherein the fixed part includes a housing and a base mounted to each other, and the movable part includes a frame and a holder received in the holder, wherein the optical element is disposed on the holder, and the driving assembly includes a first coil, a second coil, a first magnet, and a second magnet, wherein the first coil is disposed on the base, the second coil is disposed on the frame, the first magnet is disposed on the frame and located corresponding to the first coil, and the second magnet is disposed on the holder and located corresponding to the second coil.

12. The driving mechanism as claimed in claim 11, further comprising a restricting plate and a circuit board connected to each other, wherein the restricting plate is affixed to a top side of the frame, and the second coil is disposed on the circuit board and located between the holder and the restricting plate.

13. The driving mechanism as claimed in claim 12, further comprising a metal sheet spring connected between the circuit board and the base, wherein the second coil is electrically connected to an external circuit through the circuit board and the metal sheet spring.

14. The driving mechanism as claimed in claim 12, further comprising a metal sheet with high magnetic permeability and embedded in the frame.

15. The driving mechanism as claimed in claim 12, further comprising a buffer member affixed to the housing, wherein when the frame moves relative to the base to a limit position, the restricting plate contacts the buffer member.

16. The driving mechanism as claimed in claim 11, further comprising a plurality of rollers arranged along the optical axis and in contact between the base and the frame.

17. The driving mechanism as claimed in claim 16, wherein the frame has a slot and a protrusion adjacent to the slot, the rollers are received in the slot, and the protrusion protrudes from a top side of the frame.

18. The driving mechanism as claimed in claim 16, wherein the housing forms a positioning structure that protrudes from an inner surface of the housing and contacts one of the rollers.

19. The driving mechanism as claimed in claim 18, wherein the central axis of the positioning structure is offset from the central axis of the rollers toward the inner side of the driving mechanism.

20. The driving mechanism as claimed in claim 18, wherein the positioning structure forms a pit on a top surface of the housing.
